(19) United States
(12) Patent Application Publication
(10) Pub. No.: US 2012/0037828 A1
(43) Pub. Date: Feb. 16, 2012

(54) VALVE FOR CONTROLLING A FLOW

(75) Inventors: Georg Reeb, Buehl Eisental (DE); Claudius Muschelknautz, Buehl (DE)

(73) Assignee: ROBERT BOSCH GMBH, Stuttgart (DE)

(21) Appl. No.: 13/265,923

(22) PCT Filed: Apr. 9, 2010
(86) PCT No.: PCT/EP10/54680

§ 371 Date: Oct. 24, 2011

(30) Foreign Application Priority Data
Apr. 22, 2009 (DE) 10 2009 002 551.0

(51) Int. Cl. F16K 1/00

(52) U.S. Cl. 251/321

(57) ABSTRACT

A valve (100) for controlling a flow of a medium in a heating and/or cooling system of a motor vehicle comprises a valve housing (110), which has at least one first channel (140), and a regulating wheel (170), which is provided to open and close the first channel. For this purpose, the regulating wheel is arranged at a first end of a rotatably mounted drive shaft (180), which extends from the regulating wheel through an axial opening (160) of the valve housing into a spring chamber (230) arranged in the valve housing. A second end of the drive shaft arranged in the spring chamber has a spur gear (190). Furthermore, a spring (240), the first end of which is supported on the valve housing and the second end of which is supported on the spur gear, is arranged in said spring chamber.

### BACKGROUND OF THE INVENTION

The invention relates to a valve for controlling a flow of a medium in a heating system and/or cooling system of a motor vehicle.

A cooling system and/or heating system of a motor vehicle generally includes a heat source which is to be cooled, for example a vehicle engine, which is to be cooled by means of a cooling medium through free or forced convection. The heating performance or cooling performance is dependent here on the size of the flow of coolant.

The heat conducted away from the heat source by the coolant can simultaneously be used to heat a passenger compartment. For this purpose, heating circuits and cooling circuits of modern motor vehicles generally have different sub-circuits, for example a radiator branch, a bypass branch and/or a heating heat-exchanger branch. The distribution of the stream of coolant among the different branches of the cooling circuit and heating circuit is controlled here by means of at least one valve. Such a valve is known, for example, from DE 10 2006 053 307 A1. In the valve described in said document, application of pressure on one side causes hydraulic forces to bring about an axial displacement of the valve body in the direction of a transmission cover, as a result of which a frictional torque is increased. This leads to a situation in which a movement of the valve body is made more difficult.

### SUMMARY OF THE INVENTION

The object of the present invention is to make available an improved valve for controlling a flow of a medium in a heating system and/or cooling system of a motor vehicle.

A valve according to the invention for controlling a flow of a medium in a heating system and/or cooling system of a motor vehicle comprises a valve housing which has at least a first duct, and a regulating disk which is provided for opening and closing the first duct. In this context, the regulating disk is arranged at a first end of a rotatably mounted drive shaft which extends from the regulating disk through an axial opening in the valve housing into a spring space which is arranged in the valve housing. In this context, a second end of the drive shaft which is arranged in the spring space has a spur gear. Furthermore, a spring whose first end is supported on the valve housing and whose second end is supported on the spur gear is arranged in the spring space.

A spring with a relatively flat spring characteristic curve can advantageously be used here. As a result, the sealing function of the valve can be ensured even when there are relatively large tolerances of the installed components. Furthermore, an advantageous relatively constant frictional torque is achieved between the regulating disk and the duct independently of an application of pressure on both sides of the regulating disk and independently of a direction of flow through the valve.

The spring is advantageously embodied as a helical spring, wherein the drive shaft runs through the spring. As a result, a spring force is advantageously applied symmetrically to the drive shaft.

The spring preferably has a spring constant between 5 N/mm and 25 N/mm. Such a relatively low spring constant advantageously gives rise to a relatively constant frictional torque between the regulating disk and a seal of the first duct.

According to one development of the valve, an end side of the spur gear has a circumferential groove in which an annular run-up disk is arranged. In this context, the second end of the spring is supported on the run-up disk. This advantageously reduces a friction force occurring between the spring and the spur gear.

According to an additional development of the valve, a first sealing bushing is arranged at an end, facing the regulating disk, of the first duct, which sealing bushing is supported against the valve housing via a first sealing ring. In this context, the regulating disk is pressed against the first sealing bushing by the spring. This advantageously makes possible a cost-effective and reliable seal of the first duct.

The first sealing ring preferably has a cross-shaped cross section. The sealing ring then advantageously seals both when pressure is applied to the valve from the regulating disk side and when pressure is applied from the duct side. The valve is therefore suitable for both flow directions.

The spring expediently generates a pressure per unit surface area between 0.1 N/mm² and 0.5 N/mm² between the regulating disk and the first sealing bushing. From experience, this has advantageously been found to be a favorable compromise between a reliable seal of the first duct and freely moving rotatability of the regulating disk.

In one development of the valve, a bearing bushing is arranged in the axial opening and the drive shaft is led through the bearing bushing.

The valve housing can preferably be connected to an external housing in such a way that a transportation path which can be closed off by the regulating disk is produced for the medium between the first duct and the external housing. The valve can then advantageously be connected either to an external housing which has a further duct or directly to a housing of the heat source which is to be cooled, for example the vehicle engine.

In one preferred embodiment of the valve, the valve housing has a second duct, wherein the regulating disk is provided for opening and closing the first and/or the second duct. The valve can then advantageously be used to distribute the medium among different branches of the heating system and/or cooling system.

A second sealing bushing is expediently arranged at an end of the second duct facing the regulating disk, said sealing bushing being supported against the valve housing by means of a second sealing ring. In this context, the regulating disk is pressed against the second sealing bushing by the spring. Furthermore, the first and the second sealing rings are composed of the same material and have essentially the same height. This advantageously provides a uniform seal both of the first and of the second duct.

### BRIEF DESCRIPTION OF THE DRAWINGS

The invention will now be explained in more detail with reference to the appended figures, in which:

FIG. 1 is a schematic view of a valve 100, and

FIG. 2 is a schematic view of a regulating disk.

### DETAILED DESCRIPTION

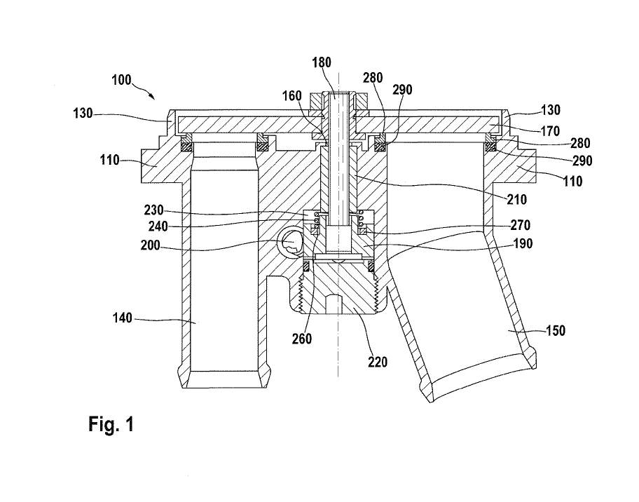

FIG. 1 is a schematic view of a section through a valve 100. The valve 100 can serve to control a flow of a medium in a heating system and/or cooling system of a motor vehicle. The medium is expediently a liquid with a high thermal capacity, for example water. The heating system and/or cooling system can serve to cool a heat source of the motor vehicle, for example a vehicle engine, and/or to heat a passenger compartment of the motor vehicle.

The valve 100 comprises a valve housing 110 which has a first duct 140 and a second duct 150. The first duct 140 and the second duct 150 serve to connect lines of the heating system and/or cooling system in which the medium circulates. One of the two ducts 140, 150 can also be dispensed with.

The valve housing 110 also has a coupling connection 130 which has the shape of an annular flange in the illustrated example. The valve housing 110 can be connected, for example bonded or screwed, in a seal-forming fashion to an external housing by means of the coupling connection 130. The external housing can be a housing cover which fits the valve housing 110 and has a further coolant duct. The external housing can, however, also be a housing of the heat source to be cooled, for example a housing of the vehicle engine. The medium can flow from the external housing into the first duct 140 and/or the second duct 150 or from the first duct 140 and/or the second duct 150 into the external housing.

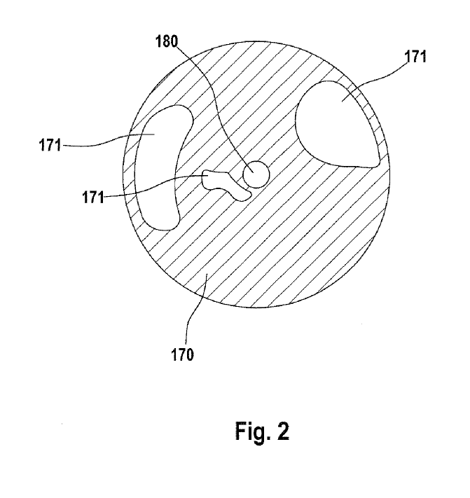

A regulating disk 170, which preferably has a circular cross section and serves to open and close a connection between the external housing and the first duct 140 and the second duct 150, is arranged inside the coupling connection 130. FIG. 2 is a schematic view of the regulating disk 170. The regulating disk 170 has a plurality of regulating openings 171. Depending on the axial rotational angle of the regulating disk 170, one of the regulating openings 171 is arranged between the external housing and the first duct 140 or the external housing and the second duct 150. By turning the regulating disk 171 it is therefore possible to open and close connections between the external housing and the first duct 140 and/or the second duct 150. Furthermore, the respective opening cross section can be varied by turning the regulating disk 170. The flow of medium can be controlled by changing the opening cross section.

The valve housing 110 also has an axial opening 160 which extends from the regulating disk 170 through the valve housing 110 as far as an outer side of the valve housing 110 which is arranged between the first duct 140 and the second duct 150. In a part of the axial opening 160 which faces the regulating disk 170 a cylindrical-casing-shaped bearing bushing 210 is arranged. A part of the axial opening 160 which faces away from the regulating disk 170 is widened to form a spring space 230. The axial opening 160 which forms the spring space 230 is closed off with a transmission cover 220 on the outer side of the valve housing 110 arranged between the first duct 140 and the second duct 150.

An essentially cylindrical drive shaft 180 extends from the regulating disk 170 through the bearing bushing 210 into the spring space 230. The end of the drive shaft 180 facing the regulating disk 170 penetrates the regulating disk 170 perpendicularly in a center of the regulating disk 170 and is rigidly connected to the regulating disk 170. Rotation of the drive shaft 180 about its longitudinal axis therefore brings about a rotation of the regulating disk 170 about its central axis.

At its end arranged in the spring space 230, the drive shaft 180 has a spur gear 190. The spur gear 190 is in engagement with a worm 200 which is arranged in the valve housing 110 and which is connected to a drive mechanism, for example a motor. The drive shaft 180 can be turned about its longitudinal axis by means of the worm 200 and the spur gear 190.

An end side, facing the bearing bushing 210, of the spur gear 190 has an annular groove 260 which runs around the drive shaft 180. An annular run-up disk 270 is arranged in the groove 260. Furthermore, a spring 240, which is preferably embodied as a helical spring, is arranged in the spring space 230. The drive shaft 180 runs axially through the spring 240. A first end of the spring 240 is supported against a section, surrounding the bearing bushing 210, of the valve housing 110. A second end of the spring 240 is supported against the spur gear 190 by means of the run-up disk 270. The spring 240 applies a force, acting in the direction of the transmission cover 220, to the drive shaft 180, by means of which force the regulating disk 170 is pressed in the direction of the first duct 140 and of the second duct 150. The run-up disk 270 serves to reduce friction between the spring 240 and the spur gear 190, said friction occurring in the case of a rotation of a drive shaft 180 around its longitudinal axis. The run-up disk 270 and the groove 260 can also be dispensed with. In this case, the second end of the spring 240 is supported directly on the spur gear 190.

An end, facing the regulating disk 170, of the second duct 150 has a cylindrical-casing-shaped sealing bushing 280 which is supported by means of an annular sealing ring 290 against a section, forming the second duct 150, of the valve housing 110. The force which is applied to the drive shaft 180 by the spring 240 presses the regulating disk 170 against the sealing bushing 280, said sealing bushing 280 being supported against the valve housing 110 by means of the sealing ring 290. The sealing bushing 280 and the sealing ring 290 bring about a seal of the junction region between the second duct 150 and the regulating disk 170. The end, facing the regulating disk 170, of the first duct 140 also has a sealing bushing 280 which is supported by means of a sealing ring 290 and by which the junction region between the first duct 140 and the regulating disk 170 is sealed. In order to ensure a uniform seal of the junction regions between the regulating disk 170 and the first duct 140 or the second duct 150, the sealing rings 290 and the sealing bushings 280 of the first duct 140 and of the second duct 150 each have the same height in the axial direction. The two sealing bushings 280 and the two sealing rings 290 are preferably each composed of the same material and have the same hardness. The two sealing bushings 280 and the two sealing rings 290 are particularly preferably each manufactured by means of the same tool.

The spring 240 preferably has a relatively flat spring characteristic curve with a spring constant between 5 N/mm and 25 N/mm. This has the advantage that the force with which the regulating disk 170 is pressed against the sealing bushing 280 fluctuates only to a slight degree due to the tolerances of the components which determine the axial installation space of the spring 240. This in turn results in a relatively constant necessary rotational torque of the regulating disk 170 against the sealing bushings 280 and therefore also in a relatively constant driving torque of the motor.

The spring preferably generates a pressure per unit surface area between 0.1 N/mm² and 0.5 N/mm² between the regulating disk 170 and the sealing bushings 280.

The sealing rings 290 are expediently embodied in such a way that they support both internal pressure and external pressure in order to permit use of the valve 100 for both flow directions. The sealing rings 290 then bring about a reliable seal of the junction regions between the first duct 140 and the regulating disk 170 and respectively between the second duct 150 and the regulating disk 170, both for the case in which a higher pressure is applied to the first duct 140 and to the second duct 150 than to the side of the regulating disk 170 facing the external housing and for the case in which a lower pressure is applied to the first duct 140 and to the second duct 150 than to the side of the regulating disk 170 facing the external housing. This can be achieved, for example, by using sealing rings 290 with a cross-shaped cross section.

1. A valve (100) for controlling a flow of a medium in a heating system and/or cooling system of a motor vehicle, the valve comprising:
a valve housing (110) which has at least a first duct (140)
and a regulating disk (170) which is provided for opening and closing the first duct (140), wherein the regulating disk (170) is arranged at a first end of a rotatably mounted drive shaft (180),
wherein the drive shaft (180) extends from the regulating disk (170) through an axial opening (160) in the valve housing (110) into a spring space (230) which is arranged in the valve housing (110),
wherein a second end of the drive shaft (180) which is arranged in the spring space (230) has a spur gear (190),
characterized in that
a spring (240) with a first end supported on the valve housing (110) and with a second end supported on the spur gear (190) is arranged in the spring space (230).

2. The valve (100) as claimed in claim 1,
wherein the spring (240) is embodied as a helical spring, wherein the drive shaft (180) runs through the spring (240).

3. The valve (100) as claimed in claim 1,
wherein the spring (240) has a spring constant between 5 N/mm and 25 N/mm.

4. The valve (100) as claimed in claim 1,
wherein an end side of the spur gear (190) has a circumferential groove (260),
wherein an annular run-up disk (270) is arranged in the groove (260),
wherein the second end of the spring (240) is supported on the run-up disk (270).

5. The valve (100) as claimed in claim 1,
wherein a first sealing bushing (280) is arranged at an end, facing the regulating disk (170), of the first duct (140), which sealing bushing (280) is supported against the valve housing (110) via a first sealing ring (290), wherein the regulating disk (170) is pressed against the first sealing bushing (280) by the spring (240).

6. The valve (100) as claimed in claim 5,
wherein the first sealing ring (290) has a cross-shaped cross section.

7. The valve (100) as claimed in claim 5,
wherein the spring (240) generates a pressure per unit surface area between 0.1 N/mm² and 0.5 N/mm² between the regulating disk (170) and the first sealing bushing (280).

8. The valve (100) as claimed in claim 1,
wherein a bearing bushing (210) is arranged in the axial opening (160),
wherein the drive shaft (180) is led through the bearing bushing (210).

9. The valve (100) as claimed in claim 1,
wherein the valve housing (110) is configured to be connected to an external housing in such a way that a transportation path which can be closed off by the regulating disk (170) is produced for the medium between the first duct (140) and the external housing.

10. The valve (100) as claimed in claim 1,
wherein the valve housing (110) has a second duct (150), wherein the regulating disk (170) is provided for opening and closing one of the first duct and the second duct (140, 150).

11. The valve (100) as claimed in claim 10,
wherein a second sealing bushing is arranged at an end of the second duct (150) facing the regulating disk (170), said sealing bushing being supported against the valve housing (110) by means of a second sealing ring,
wherein the regulating disk (170) is pressed against the second sealing bushing (280) by the spring (240),
wherein the first sealing ring (290) and the second sealing ring are composed of the same material and have essentially the same height.

12. The valve (100) as claimed in claim 1,
wherein the valve housing (110) has a second duct (150), wherein the regulating disk (170) is provided for opening and closing the first and the second duct (140, 150).

13. The valve (100) as claimed in claim 12,
wherein a second sealing bushing is arranged at an end of the second duct (150) facing the regulating disk (170), said sealing bushing being supported against the valve housing (110) by means of a second sealing ring,
wherein the regulating disk (170) is pressed against the second sealing bushing (280) by the spring (240),
wherein the first sealing ring (290) and the second sealing ring are composed of the same material and have essentially the same height.

14. The valve (100) as claimed in claim 2, wherein the spring (240) has a spring constant between 5 N/mm and 25 N/mm.

15. The valve (100) as claimed in claim 14,
wherein an end side of the spur gear (190) has a circumferential groove (260),
wherein an annular run-up disk (270) is arranged in the groove (260),
wherein the second end of the spring (240) is supported on the run-up disk (270).

16. The valve (100) as claimed in claim 15,
wherein a first sealing bushing (280) is arranged at an end, facing the regulating disk (170), of the first duct (140), which sealing bushing (280) is supported against the valve housing (110) via a first sealing ring (290), wherein the regulating disk (170) is pressed against the first sealing bushing (280) by the spring (240).

17. The valve (100) as claimed in claim 16,
wherein the first sealing ring (290) has a cross-shaped cross section.

18. The valve (100) as claimed in claim 17, wherein the spring (240) generates a pressure per unit surface area between 0.1 N/mm² and 0.5 N/mm² between the regulating disk (170) and the first sealing bushing (280).

19. The valve (100) as claimed in claim 18,
wherein a bearing bushing (210) is arranged in the axial opening (160),
wherein the drive shaft (180) is led through the bearing bushing (210).

20. The valve (100) as claimed in claim 19, wherein the valve housing (110) is configured to be connected to an external housing in such a way that a transportation path which can be closed off by the regulating disk (170) is produced for the medium between the first duct (140) and the external housing.
